(19) United States
(12) Patent Application Publication
(10) Pub. No.: US 2023/0276180 A1
(43) Pub. Date: Aug. 31, 2023

(54) HEARING DEVICE

(71) Applicant: GN Hearing A/S, Ballerup (DK)

(72) Inventor: Christopher Wessel LINDBERG, Copenhagen (DK)

(73) Assignee: GN Hearing A/S, Ballerup (DK)

(21) Appl. No.: 18/110,371

(22) Filed: Feb. 16, 2023

(30) Foreign Application Priority Data
Feb. 28, 2022 (DK) PA 2022 70071
Mar. 3, 2022 (EP) 22159952.5

(51) Int. Cl. H04R 25/00

(52) U.S. Cl. CPC H04R 25/30

(57) ABSTRACT

Disclosed is a hearing device comprising an antenna and a wireless communication unit, the wireless communication unit being coupled to the antenna, the wireless communication unit and the antenna being configured for transmission and reception of electromagnetic signals. The hearing device comprises a detector configured to detect a reflected power signal indicating an amount of power reflected towards the wireless communication unit from the antenna and a processing unit configured to receive the reflected power signal, and to determine a state of the hearing device, including a first state in which the hearing device is not worn in its operational position in or at the ear of a user. Disclosed is also a method of determining a state of a hearing device, including a state in which the hearing device is not worn in its operational position in or at the ear of a user.

### RELATED APPLICATION DATA

This application claims priority to, and the benefit of, Danish Patent Application No. PA 2022 70071 filed on Feb. 28, 2022, and European Patent Application No. 22159952.5 filed on Mar. 3, 2022. The entire disclosures of the above applications are expressly incorporated by reference herein.

### FIELD

The present disclosure relates to hearing devices. More specifically, the disclosure relates to a hearing device comprising a wireless communication unit and an antenna, the wireless communication unit and the antenna being configured for transmission and reception of electromagnetic signals. Particularly, the disclosure relates to determining a state of the hearing device.

### BACKGROUND

Hearing devices capable of wireless communication are well known in the art, and such hearing devices typically comprises wireless transceivers and one or more antennas,

In some cases, the antenna in a hearing device needs to be tuned to adapt to specific surroundings, particular positioning in or at the ear, etc. In this respect a signal strength indicator (RSSI) indicating a signal strength of a signal received via the antenna can assist with tuning of the antenna. In some cases, a value of a tuning element may be varied to determine a value of the tuning element that produces a maximum RSSI signal.

In some cases, a hearing device transceiver may transmit signals at a plurality of different frequencies in accordance with a frequency hopping sequence to an antenna, collect two dimensional (2-D) reflection coefficient data comprising the reflection coefficient of the antenna as a function of frequency and of time in response to transmission of the signals and detect a particular input gesture of a plurality of input gestures of the wearer using the 2-D reflection coefficient data, and implement a predetermined function of the ear-worn device in response to detecting the particular input gesture.

However, there is a need for an improved hearing device in which the functionalities of the hearing device may be improved.

### SUMMARY

According to a first aspect a hearing device is disclosed, the hearing device comprising an antenna and a wireless communication unit. The wireless communication unit is coupled to the antenna, the wireless communication unit and the antenna being configured for transmission and reception of electromagnetic signals. The hearing device further comprises a detector configured to detect a reflected power signal, the reflected power signal indicating an amount of power reflected towards the wireless communication unit from the antenna, and a processing unit configured to receive the reflected power signal and to determine a state of the hearing device, including a first state in which the hearing device is not worn in its operational position at the ear of a user.

According to an other aspect, disclosed is a method of determining a state of a hearing device, the hearing device comprising an antenna, a wireless communication unit and a processing unit. The wireless communication unit is coupled to the antenna, the wireless communication unit and the antenna being configured for transmission and reception of electromagnetic signals. The method comprises detecting a reflected power signal indicating an amount of power reflected towards the wireless communication unit from the antenna, receiving the reflected power signal in the processing unit, and determining a state of the hearing device, including a first state in which the hearing device is not worn in its operational position. In an embodiment, the hearing device further comprises a detector, the detector being configured to detect the reflected power signal.

It is an advantage of being able to detect a state of the hearing device in which the hearing device is not worn in its operational position at the ear of a user, in that thereby, the hearing device may be operated according to such state. It is additionally an advantage that the state of the hearing device can be determined by using a measurement, such as a simple measurement, of reflected power. It is an additional advantage that the hearing device may be prevented from squealing when removed from the ear.

In an embodiment, the hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system. The hearing device may be a first hearing device and/or a second hearing device of a binaural hearing device.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprised in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication.

The hearing device comprises an antenna. In one or more embodiments, the antenna is an electric antenna. The electric antenna may be configured for wireless communication at a first frequency. The first frequency may be above 800 MHz, preferably a wavelength between 900 MHz and 6 GHz. The first frequency may be 902 MHz to 928 MHz. The first frequency may be 2.4 to 2.5 GHz. The first frequency may be 5.725 GHz to 5.875 GHz. The electric antenna may be any antenna capable of operating at these frequencies, and the electric antenna may be a resonant antenna, such as monopole antenna, such as a dipole antenna, etc. The resonant antenna may have a length of λ/4, such as λ/4±10%, or any integer multiple thereof, A being the wavelength corresponding to an emitted electromagnetic field, emitted from the antenna.

In an embodiment, the hearing device may additionally comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more antenna(s). In some embodiments, the hearing device may comprise an electric antenna and a magnetic antenna.

The hearing device comprises a wireless communication unit. In an embodiment, the hearing device may comprise one or more wireless communication unit(s). The wireless communication unit, or the one or more wireless communication unit(s), may comprise one or more wireless receiver(s), one or more wireless transmitter(s), one or more transmitter-receiver pair(s) and/or one or more transceiver(s). The wireless communication unit, such as at least one of the one or more wireless communication unit(s), may be coupled to the antenna, such as to the one or more antenna(s) if applicable. The wireless communication unit may be configured for converting a wireless signal received by the antenna, such as the at least one of the one or more antenna(s), into a second electric input signal. The hearing device may be configured for wired/wireless audio communication, e.g. enabling the user to listen to media, such as music or radio and/or enabling the user to perform phone calls. The hearing device may be configured to receive data via the wireless communication unit, such as settings data, such as parameter data, such as synchronization data, such as audio, etc. In some embodiments, the wireless communication unit, such as at least one of the one or more wireless communication units, is coupled to the antenna, such as interconnected with the antenna. The wireless communication unit and the antenna being configured for transmission and reception of electromagnetic signals.

The one or more wireless communication units may be configured for communication using any protocol as known for a person skilled in the art, including Bluetooth, WLAN standards, manufacture specific protocols, such as tailored proximity antenna protocols, such as proprietary protocols, such as low-power wireless communication protocols, RF communication protocols, magnetic induction protocols, etc. The one or more wireless communication units may be configured for communication using same communication protocols, or same type of communication protocols, or the one or more wireless communication units may be configured for communication using different communication protocols.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device comprises a detector.

The hearing device comprises a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise e.g. synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/ear mold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

The hearing device comprises a detector configured to detect a reflected power signal, the reflected power signal indicating an amount of power reflected towards the wireless communication unit from the antenna.

In an embodiment, the reflected power signal indicating an amount of power reflected towards the wireless communication unit depends on the reflection coefficient of the antenna, such as on the reflection coefficient S11. The reflected power may be a percentage of power provided from the wireless communication unit to the antenna. In an embodiment, the reflected power signal may be a percentage of the wireless output signal.

The reflected power, such as a level of reflected power, may be determined, for example, by a degree of matching between the wireless communication unit and the antenna. Since antennas are typically sensitive to their surrounding environment, the performance of the hearing device, including the wireless communication unit and the antenna, is configured to be optimal when the hearing device is worn in its intended operational position in or at an ear of a user. It has been found that when a hearing device is removed from the intended operational position in or at an ear of a user, the reflected power may change, as the surrounding environment of the antenna changes, so that less power may be delivered from the wireless communication unit to the antenna, and thus resulting in an increase of reflected power. It is an advantage that by detecting a reflected power signal indicating an amount of power reflected towards the wireless communication unit from the antenna, a state of the hearing device may be determined, based on the reflected power signal. The state of the hearing device comprising a first state in which the hearing device is not worn in its operational position in or at the ear of a user.

The processing unit is configured to receive the reflected power signal and to determine a state of the hearing device, including a first state in which the hearing device is not worn in its operational position at the ear of a user.

In an embodiment, the processing unit is configured to, in response to determining that the state of the hearing device is the first state, control at least one hearing device setting. In an embodiment, the processing unit is configured to provide a control signal for controlling the at least one hearing device setting. The processing unit may be a signal processor for the hearing device.

In an embodiment, the hearing device comprises at least one hearing device transducer. The hearing device setting may be an on/off setting of the at least one transducer. For example, the at least one transducer may be off when the hearing device is in the first state. In an embodiment, the at least one transducer is a speaker, and the speaker is off when the hearing device is in the first state. In an embodiment, the at least one transducer is a microphone, such as a microphone in an in-the-ear part of the hearing device, and the microphone is off when the hearing device is in the first state. In an embodiment, the on/off setting may be a mute on/mute off setting.

Thus, the at least one transducer may be in an off state when the hearing device is not worn.

In an embodiment, the hearing device comprises a plurality of hearing device transducers, and the hearing device settings are controlled only for a part of the plurality of hearing device transducers, such as controlled only for one transducer. In an embodiment, the hearing device comprises a speaker and a microphone in an in-the-ear part of a hearing device, and the hearing device settings of only the speaker may be controlled. In an embodiment, the hearing device comprises a speaker and a microphone in an in-the-ear part of a hearing device, and the hearing device settings of only the microphone in an in-the-ear part of the hearing device may be controlled.

In an embodiment, the at least one hearing device setting is a gain setting. The processing unit may be configured to control a gain setting, such as a gain setting for at least one hearing device transducer. In an embodiment, the processing unit is configured to provide a control signal for controlling the gain setting for at least one hearing device transducer, when the hearing device is determined to be in the first state.

The gain setting may for example be lowered or turned down when the hearing device is in the first state.

In an embodiment, an interconnection between the wireless communication unit and the antenna comprises at least one microwave coupler, the detector being configured to detect coupled power from the microwave coupler.

In an embodiment, the microwave coupler is configured to couple power reflected from the antenna towards the wireless communication unit to the detector to provide the reflected power signal. In an embodiment, the microwave coupler comprises at least a part of a transmission line coupling or interconnecting the wireless communication unit and the antenna. The microwave coupler may have a first end connected to ground via a dissipating element and a second end connected to the detector.

It is an advantage of determining a quality of the antenna matching with the wireless communication unit by using reflected power, in that reflected power can be detected within the hearing device, independent on any received signals. By measuring reflected power using a microwave coupler, reflected power is determined using microwave techniques. Hereby, local electromagnetic fields, such as electromagnetic fields contained in the hearing device, such as contained in e.g. a PCB of the hearing device, forms the basis of a determination of the state of the hearing device. It is an advantage that the determination is independent on e.g. a signal strength of a received signal, such as the use of RSSI (Received Signal Strength Indicator) as the determination is thereby independent on received signals, and any path travelled by such received signals.

In an embodiment, the processing unit being configured to receive the reflected power signal, may determine whether the reflected power signal indicates that the amount of reflected power is above a first threshold. In accordance with a determination, by the processing unit, that the reflected power signal indicates that the reflected power is above a first threshold, determining that the hearing device is in the first state.

Determining that the reflected power is above a first threshold may indicate that the matching, such as an impedance matching, between the antenna and the wireless communication unit is outside the normal operating range when the hearing device is worn in or at the ear of a user. As antenna input impedance is typically sensitive to the antenna environment, determining that the reflected power is a above a first threshold, may indicate that hearing device has been removed from the normal operating position in or at the ear of a user, and thus is in the first state.

In an embodiment, the processing unit being configured to receive the reflected power signal, may determine whether a change in the reflected power signal is above a second threshold. In accordance with a determination that a change in the reflected power signal is above a second threshold, determining that the hearing device is in the first state.

Determining that a change in the reflected power signal is above a second threshold may indicate that the matching, such as the impedance matching, between the antenna and the wireless communication unit is changing, and outside a range of change which would be within changes experienced during normal operation of the hearing device when the hearing device is worn in or at the ear of a user. As antenna input impedance is typically sensitive to the antenna environment, determining that a change in the reflected power signal is a above a second threshold, may indicate that hearing device has been removed from the normal operating position in or at the ear of a user, and thus is in the first state.

In an embodiment, the second threshold may correspond to a change in reflected power of more than 10%, such as of more than 15% of the reflected power signal, such as of the reflected power signal at a first time.

In an embodiment, a first reflected power signal is detected at a first time and a second reflected power signal is detected at a second time, and a change in the reflected power signal is determined as the difference between the first reflected power signal and the second reflected power signal. In an embodiment, the difference between the first time and the second time is below 1 second, such as below 50 ms, such as below 10 ms, is between 10 ms and 1 second, between 10 ms and 50 ms.

In an embodiment, the first threshold and/or the second threshold may be determined during a fitting procedure of the hearing device. For example, a normal operating range of reflected power when the hearing device is worn in or at the ear of a user during operation may be determined during the fitting procedure. For example, a range of change which would be within changes experienced during normal operation of the hearing device, when the hearing device is worn in or at the ear of a user, may be determined during the fitting procedure.

In an embodiment, the first threshold and/or the second threshold is/are predetermined threshold values. In an embodiment, the reflected power signal is determined as a percentage of the power of the wireless output signal. The first threshold may correspond to a percentage of reflected power being higher than 20%, such as higher than 30%, such as higher than 50%.

In an embodiment the detector configured to detect the reflected power signal is provided in the wireless communication unit or in the processing unit.

In an embodiment, a fitting procedure includes matching an antenna with the wireless communication unit, such as matching the antenna input impedance with an impedance of the wireless communication unit, such as typically 50 Ohm.

In an embodiment, the hearing device further has a second state in which the hearing device is worn in its operational position at the ear of a user. The second state may be a default state, such as a default operating state. In an embodiment, the hearing device will be in the second state in accordance with a determination, by the processing unit, that the reflected power signal indicates that the reflected power is below the first threshold. In an embodiment, the hearing device will be in the second state in accordance with a determination that a change in the reflected power signal is below the second threshold.

In an embodiment, the hearing device in the first state is configured to be operated in an idle mode, and wherein the hearing device in the second state is configured to be operated in one of a number of operational modes. The number of operational modes may include standard operational modes, noisy environment operational modes, quiet environment operational mode, directional microphone mode or focus mode, omnidirectional microphone mode or all access mode, etc.

In an embodiment, the processing unit is configured to, in response to determining that the state of the hearing device is the first state, operate the hearing device in idle mode. In an embodiment the processing unit is configured to, in response to determining that the state of the hearing device is the second state, operate the hearing device in one of a number of operational modes. In an embodiment, the idle mode includes a charging mode. In an embodiment, the processing unit may be configured to switch from an operational mode to the idle mode and vice versa, e.g. in response to determining a state of the hearing device. In an embodiment, the processing unit may be configured to switch between the number of operational modes.

In an embodiment, the reflected power signal indicating an amount of power reflected towards the wireless communication unit correlates with a reflection coefficient of the antenna.

In an embodiment, the reflected power signal indicating an amount of power reflected towards the wireless communication unit is detected as a function of frequency and time. Typically, the reflected power signal is detected as a function of frequency over the intended operating frequency band for the antenna.

The processing unit may determine an amount of power reflected from the antenna. The processing unit may determine the reflection coefficient for the antenna, such as the reflection coefficient for the antenna at a particular point in time, such as the reflection coefficient depending on a present environment for the hearing device.

In an embodiment, the hearing device may further comprise a memory configured to store reflected power signals as a function of frequency and time. The memory may alternatively or additionally store the reflection coefficient, such as the S11 value, such as store the reflection coefficient over time. Thus, the S11 value may be stored for a user over time.

In an embodiment, the antenna is configured to emit and transmit electromagnetic radiation at a frequency above 1 GHz, such as above 2 GHz, such as about 2.4 GHz, for example at a frequency between 1 GHz and 6 GHz. In an embodiment, the antenna as coupled to the wireless communication unit is configured to emit and transmit electromagnetic radiation above 1 GHz, such as above 2.4 GHz, for example at a frequency between 1 GHz and 6 GHz. In an embodiment, the, the antenna as coupled to the wireless communication unit is configured to emit and transmit electromagnetic radiation in the 2. 4 GHz ISM band, i.e. in the range of 2.402 GHz-2.480 GHz. In an embodiment, the antenna is a resonant antenna.

In an embodiment, the hearing device further comprises hearing device charging elements, such as hearing device wireless charging elements. The hearing device charging elements may include one or more charging coil(s), charging electronic circuit, such as a battery power management circuit, e.g. to charge a rechargeable battery of the hearing device. The hearing device may comprise a rechargeable battery. Typically, the hearing device is configured to be in the first state and operating in a charging mode, or idle mode, when charging, the charging mode allowing communication between the hearing device and the charger.

It is an advantage of being able to detect a state of the hearing device in which the hearing device is not worn in its operational position at the ear of a user, in that thereby, the hearing device may be operated according to such state. For example, the hearing device, in the first state, may be operated so that e.g. a gain for the speaker is significantly reduced, or so that an output transducer, such as a speaker, is turned off. It is advantageous, that the hearing device, in the first state is not turned completely off, but that only an output sound from the hearing device, such as from a transducer, such as an output transducer, such as a speaker, is turned off or significantly reduced, while the hearing device is still capable of communication e.g. with a charger for charging a battery of the hearing device. Hereby, in an embodiment, the hearing device may be positioned in a charger while no squealing is heard, even without the user having to manually adjust the hearing device to be in an idle mode or charging mode.

In an embodiment, the hearing device further comprises a matching network, the matching network being configured to match antenna impedance and wireless communication unit impedance, to optimize power delivered to the antenna from the wireless communication unit, and vice versa, when the hearing device is worn in its operational position at the ear of a user during use. In an embodiment, the matching network is adjusted during a fitting procedure for the hearing device. The reflection coefficient for the antenna, such as the S11, indicates the degree of matching between the antenna and the wireless communication unit.

In an embodiment, magnitude of the reflection coefficient for the antenna is detected. In an embodiment magnitude and phase of the reflection coefficient for the antenna is detected. In an embodiment, the detector is configured to detect magnitude of the reflection coefficient. In an embodiment, the detector is configured to detect magnitude and phase of the reflection coefficient.

In an embodiment, the first threshold is correlated with the reflection coefficient, S11.

In an embodiment, the first threshold may for example correspond to a reflection coefficient having a normalized magnitude, i.e. a normalized inductive impedance (positive imaginary part) having a distance of more than 0.5 to center of the Smith chart. In an embodiment, the processing unit may, based on the reflected power signal, determine that when the distance from the ideal match of a normalized inductive impedance is above the first threshold, such as above 0.5, then the state of the hearing device is the first state, i.e. off the ear. In an embodiment, the processing unit may, based on the reflected power signal, determine that when the distance from the ideal match of the normalized inductive impedance is below the first threshold, such as below 0.5, then the state of the hearing device is the second state, i.e. at or on the ear.

In an embodiment, the first threshold may additionally or alternatively be determined or confirmed based on a detected shift in phase of the reflection coefficient. For example, if a shift in phase above 90 deg, such as above 120 deg, such as above 180 deg, is detected, the processing unit may determine that a change in position of the hearing device has occurred.

In an embodiment, the processing unit may, based on the reflected power signal, determine the state of the hearing device based on the magnitude of the reflection coefficient.

In an embodiment, the processing unit may confirm the determination of the state of the hearing device based on a shift in phase of the reflection coefficient.

In an embodiment, the processing unit may, based on the reflected power signal and/or a shift in phase of the reflection coefficient, determine a state of the hearing device.

In an embodiment, the wireless communication unit may be configured for converting the second electric output signal into a wireless output signal, the wireless output signal being transmitted from the wireless communication unit to the antenna, typically along a transmission line. The power of the reflected power signal may be a percentage of the power of the wireless output signal. Typically, the reflection coefficient for the antenna indicates the amount of power reflected.

In the other aspect, a method of determining a state of a hearing device is disclosed. The method comprising: detecting a reflected power signal indicating an amount of power reflected towards the wireless communication unit from the antenna, receiving the reflected power signal in the processing unit, and determining a state of the hearing device, including a first state in which the hearing device is not worn in its operational position. The hearing device may further comprise a detector.

In an embodiment, the method further comprises in response to determining that the state of the hearing device is the first state, controlling at least one hearing device setting.

In an embodiment, the hearing device comprises at least one hearing device transducer, and the method comprises controlling an on/off setting of the at least one transducer.

In an embodiment, the at least one hearing device setting is a gain setting, and the method comprises controlling a hearing device gain.

In an embodiment, wherein the hearing device in the first state is configured to be operated in an idle mode, and wherein the hearing device in the second state is configured to be operated in one of a number of operational modes, the method further comprises: operating the hearing device in an idle mode in response to determining that the hearing device is in the first state; operating the hearing device in one of a number of operational modes, in response to determining that the hearing device is in the second state.

In a further aspect, a system comprising a hearing device as herein disclosed and a charger, wherein the hearing device comprises hearing device charging elements configured to enable charging of a rechargeable battery and wherein the charger is configured to re-charge a rechargeable battery of the hearing device, characterized in that the hearing device is configured to be operating in the first state when connected to the charger.

In an embodiment, the hearing device comprises a rechargeable battery, and the charger is configured to charge the rechargeable battery.

The present disclosure relates to different aspects including the hearing device and the method described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary hearing device according to the present disclosure,

FIGS. 2a-2b schematically illustrate other exemplary hearing devices according to the present disclosure,

FIG. 3a schematically illustrates an exemplary hearing device comprising a microwave coupler. FIG. 3b schematically illustrates a microwave coupler,

FIG. 4a schematically illustrates an exemplary hearing device comprising a rechargeable battery, according to the present disclosure,

FIG. 4b schematically illustrates a system comprising an exemplary hearing device comprising a rechargeable battery; and a charger, according to the present disclosure,

FIG. 5 shows a Smith chart including exemplary values of normalized impedance values,

FIG. 6 is a graph showing the reflection coefficient vs frequency,

FIG. 7 is a flowchart illustrating the method as herein disclosed.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

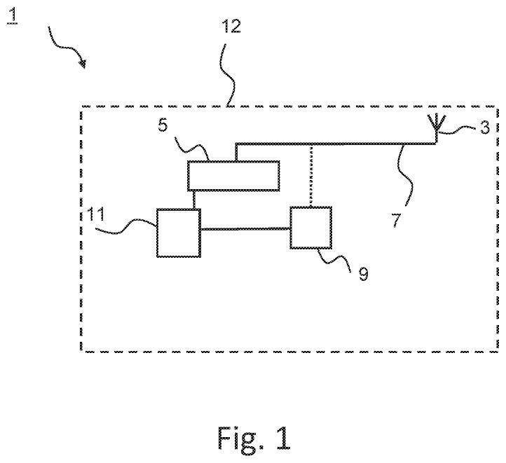

FIG. 1 schematically illustrates an exemplary hearing device according to the present disclosure. FIG. 1 shows hearing device 1 comprising an antenna 3 and a wireless communication unit 5. The wireless communication unit 5 is coupled to the antenna 3, and the wireless communication unit 5 and the antenna 3 are configured for transmission and reception of electromagnetic signals. The hearing device further comprises a detector 9 configured to detect a reflected power signal indicating an amount of power reflected towards the wireless communication unit 5 from the antenna 3. Processing unit 11 is configured to receive the reflected power signal, and to determine a state of the hearing device, including a first state in which the hearing device is not worn in its operational position in or at the ear of a user. The determination may be based on the reflected power signal. The hearing device may be provided in a hearing device housing 12.

The processing unit 11 may be configured to, in response to determining that the state of the hearing device is the first state, control at least one hearing device setting (not shown). The antenna 3 may be coupled to the wireless communication unit 5 via an interconnection 7, such as via a transmission line 7.

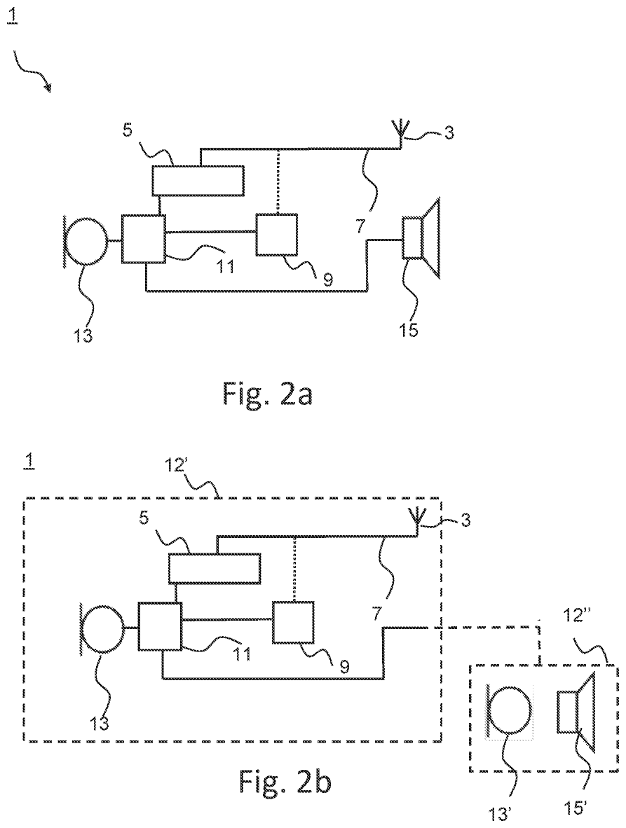

FIG. 2a schematically illustrates another exemplary hearing device according to the present disclosure. The hearing device correspond to the hearing device in FIG. 1 and comprises an antenna 3 and a wireless communication unit 5. The wireless communication unit 5 is coupled to the antenna 3, and the wireless communication unit 5 and the antenna 3 are configured for transmission and reception of electromagnetic signals. The hearing device further comprises a detector 9 configured to detect a reflected power signal indicating an amount of power reflected towards the wireless communication unit 5 from the antenna 3. Processing unit 11 is configured to receive the reflected power signal, and to determine a state of the hearing device, including a first state in which the hearing device is not worn in its operational position in or at the ear of a user. The determination may be based on the reflected power signal. The hearing device in FIG. 2a additionally comprises at least one hearing device transducer 13, 15, such as for example microphone 13 and transducer 15. It is envisaged that the hearing device may comprise a plurality of microphones 13, 13′. Additionally, the hearing device may comprise more than one speaker 15, 15′. FIG. 2a generally illustrates the concept of having transducer(s) in the hearing device, the illustrated positioning of the transducers is not to scale. The transducers 13, 15 may be positioned in same or different hearing device housings, and there may be more than one microphone and/or more than one receiver (speaker).

In an embodiment, the hearing device is a behind-the-ear hearing device, having an output transducer, such as a receiver (speaker), in the behind-the-ear housing. In an embodiment, the hearing device has a behind-the-ear part and an in-the-ear part, such as a RIE, or a MaRie type device, having either a receiver (speaker) in the in-the-ear part of the hearing device, or having both a receiver (speaker) and a microphone in the in-the-ear part of the hearing device. In an embodiment, the hearing device is an in-the-ear hearing device. As illustrated in FIG. 2b, the hearing device may be a MaRie type device, having a microphone 13′ and a speaker 15′ in the in-the-ear part 12″ of the hearing device, while antenna 3, wireless communication unit 5 and processing unit 11 are provided in the behind-the-ear part 12′ of the hearing device.

In response to determining, by the processing unit, that the state of the hearing device is the first state, at least one hearing device setting is controlled. The at least one hearing device setting may be a setting for at least one transducer 13, 13′,15, 15′ of the plurality of transducers 13, 13′,15, 15′. The at least one transducer including one or more microphones 13, 13′ and one or more speakers 15, 15′. For example, the hearing device setting may be an on/off setting of the at least one transducer. In one example, the hearing device setting is an on/off setting for a microphone 13′ provided in the in-the-ear part 12″ of the hearing device. Thus, the hearing device settings may be controlled only for a part of the plurality of hearing device transducers and may for example be an on/off setting of the at least one transducer.

In an example, the hearing device setting is a gain setting, such as a gain setting for at least one of the plurality of transducers.

It is noted that even when the detector 9 is illustrated as being a separate detector 9, the detector 9 configured to detect the reflected power signal may be provided in the wireless communication unit 5 or may be provided in the processing unit 11.

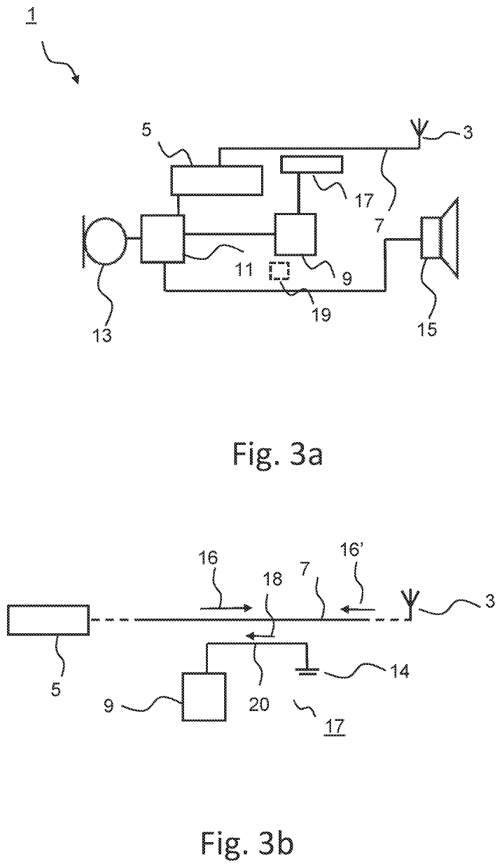

FIG. 3a schematically illustrates a hearing device 1. The hearing device may be distributed in one or more housings as discussed above. In FIG. 3a, interconnection 7 between the wireless communication unit 5 and the antenna 3 comprises at least one microwave coupler 17. The detector 9 is configured to detect coupled power from the microwave coupler 17. The microwave coupler 17 is configured to couple power reflected from the antenna 3 towards the wireless communication unit 5 to the detector 9 to provide the reflected power signal.

FIG. 3b schematically illustrates an exemplary microwave coupler, however, it is envisaged that any form of microwave coupler may be used.

In FIG. 3b, the wireless communication unit 5 and the antenna 3 are coupled or interconnected via transmission line 7. A wireless output signal 16 to be transmitted by the antenna 3 is sent from the wireless communication unit 5 to the antenna 3. At least a part of the wireless output signal 16 may be reflected from the antenna 3 generating a reflected signal 16′, the size or power of the reflected signal depending on antenna matching, that is impedance matching between the antenna and the wireless communication unit, and thus the reflection coefficient of the antenna. The parasitic conducting element 20 is positioned adjacent transmission line 7 and a part 18 of the reflected signal 16′ will be coupled to the parasitic conducting element 20, and the detector 9 is configured to detect the reflected power signal 18 indicating an amount of power reflected towards the wireless communication unit 5 from the antenna 3. Thus, the reflected power signal 18 indicates an amount of power of the reflected signal 16′.

The wireless communication unit 5 may be configured for converting the second electric output signal into a wireless output signal 16, the wireless output signal 16 being transmitted from the wireless communication unit 5 to the antenna 3, typically along transmission line 7. The power of the reflected signal 16′ may be a percentage of the power of the wireless output signal. The power of the reflected power signal 18 is likewise a percentage of the power of the wireless output signal 16. Typically, the reflection coefficient for the antenna indicates the amount of power reflected.

As is seen, the microwave coupler 17 is in this particular example implemented so as to comprise at least a part of a transmission line 7 coupling the wireless communication unit 5 and the antenna 3.

The processing unit may determine an amount of power reflected from the antenna. The processing unit may determine the reflection coefficient for the antenna, such as the reflection coefficient for the antenna at a particular point in time, such as the reflection coefficient depending on a present environment for the hearing device.

The hearing device may further comprise a memory 19 configured to store reflected power signals as a function of frequency and time. The memory may alternatively or additionally store the reflection coefficient, such as the S11 value, such as store the reflection coefficient over time. Thus, the S11 value may be stored for a user over time.

In some embodiments, in accordance with a determination that the reflected power signal, as detected by detector 9, indicates that the reflected power is above a first threshold, determining that the hearing device is in the first state and in accordance with a determination that a change in the reflected power signal is above a second threshold, determining that the hearing device is in the first state. The first threshold and/or the second threshold may be determined during a fitting procedure of the hearing device.

The hearing device may further have a second state in which the hearing device is worn in its operational position at the ear of a user. The hearing device may for example in the first state be configured to be operated in an idle mode, and the hearing device may in the second state be configured to be operated in one of a number of operational modes.

The processing unit may be configured to, in response to determining that the state of the hearing device is the first state, operate the hearing device in idle mode, and wherein the processing unit is configured to, in response to determining that the state of the hearing device is the second state, operate the hearing device in one of a number of operational modes.

The reflected power signal may indicate an amount of power reflected towards the wireless communication unit and may correspond to or correlate with a reflection coefficient of the antenna. Typically, the reflected power signal indicating an amount of power reflected towards the wireless communication unit is detected as a function of frequency and time.

The antenna 3 may for example be an electric antenna. The antenna 3 may for example be configured to emit and transmit electromagnetic radiation at a frequency above 1 GHz.

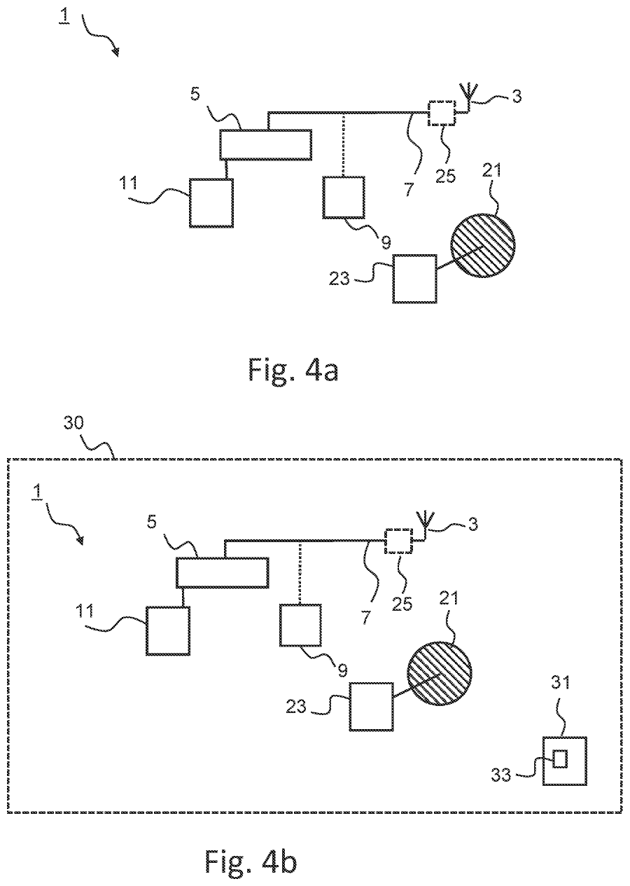

FIG. 4 schematically illustrates a hearing device 1 such as the hearing device 1 as shown in FIG. 1. The hearing device in FIG. 4 additionally optionally comprises a matching network 25. The matching network 25 being any conventionally known matching network, configured to match antenna impedance and wireless communication unit impedance, so as to optimize power delivered to the antenna 3, when the hearing device 1 is worn in its operational position at the ear of a user during use.

The hearing device as illustrated in FIG. 4 further comprises hearing device charging elements 23 and a rechargeable battery 21. The hearing device charging elements may be wireless hearing device charging elements, such as hearing device charging element 23 allowing for wireless charging of the rechargeable battery. It is an advantage of having rechargeable batteries in a hearing device in that an exchange of the battery, which can be hard to perform due to the small sizes, can be performed less frequently.

The hearing device charging elements may include one or more charging coil(s) (not shown), charging electronic circuit (not shown), such as a battery power management circuit, e.g. to charge a rechargeable battery of the hearing device. Typically, the hearing device is in an idle mode or a charging mode when charging, the idle mode or charging mode allowing communication between the hearing device and the charger.

It is an advantage of being able to detect a state of the hearing device in which the hearing device is not worn in its operational position at the ear of a user, in that thereby, the hearing device may be operated according to such state. For example, the hearing device, in the first state, may be operated so that e.g. a gain for the speaker is significantly reduced, or so that an output transducer, such as a speaker, is turned off. It is advantageous, that the hearing device, in the first state is not turned completely off, but that only an output sound from the hearing device, such as from a transducer, such as an output transducer, such as a speaker, is turned off or significantly reduced, while the hearing device is still capable of communication e.g. with a charger for charging a battery of the hearing device. Hereby, in an embodiment, the hearing device may be positioned in a charger while no squealing is heard, even without the user having to manually adjust the hearing device to be in an idle mode or charging mode.

FIG. 4b shows a system 30 comprising a hearing device as shown in FIG. 4a and a charger 31. The hearing device comprises hearing device charging elements configured to enable charging of a rechargeable battery. The charger 31 comprises charging elements 33, such as charging elements configured to co-operate with the hearing device charging elements 23 to charge a rechargeable battery of the hearing device. The charger 31 is configured to re-charge a rechargeable battery of the hearing device. The hearing device is configured to be operating in the first state when connected to the charger.

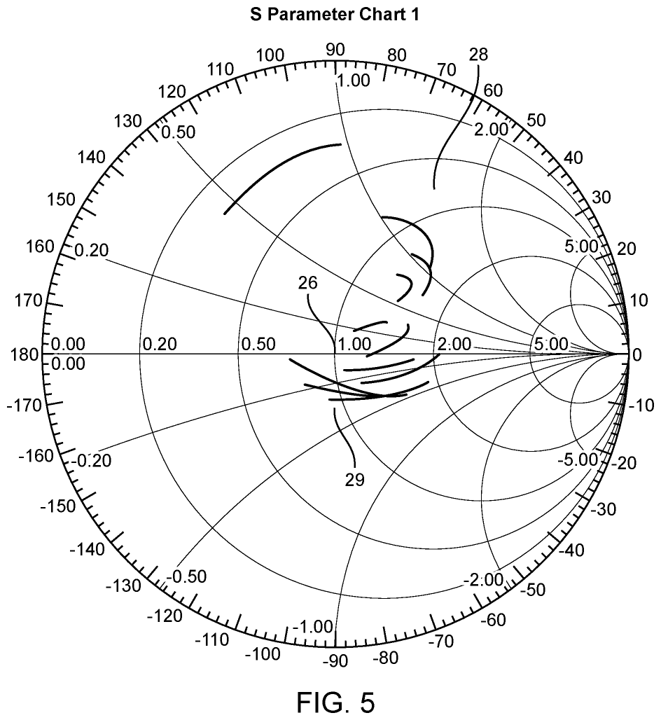

FIG. 5 shows a Smith chart of exemplary normalized inductive impedances as determined by the hearing device and the method as disclosed herein. The ideal normalized inductive impedance is about 1, thus, for an antenna having an optimized transmission power, the normalized inductive impedance should be as near the center of the Smith chart, marked with reference 26, as possible. Thus, for a hearing device configured to be worn in or at the ear of a user, the antenna, and any matching networks, will be configured to have an optimized transmission power when worn at the operational position in or at the ear of a user. Thus, a hearing device configured to have an optimized transmission power when worn at the operational position in or at the ear, will have a low reflection coefficient.

The Smith chart in FIG. 5 shows normalized detected magnitude and phase of the reflection coefficient for the antenna. Illustrated is values as measured for a number of test persons and corresponding fitted hearing device.

As is seen from the Smith chart in FIG. 5, a number of measurements show a reflection coefficient having a normalized magnitude, i.e. a normalized inductive impedance, around the center 26 of the Smith chart, i.e. a distance from the center 26 which is below 0.5., see reference 29. This corresponds to a hearing device being worn in the operational position in or at the ear of a user, that is a hearing device in the second state, that is for which state the hearing device fitting was performed, and thus for which state the antenna matching was performed. As is seen from FIG. 5, the reflection coefficient is low, for example such that there is less than 10% reflected power, such that there is less than 20% reflected power.

As is also seen from the Smith chart in FIG. 5, a number of measurements show a reflection coefficient having a normalized magnitude, i.e. a normalized inductive impedance further away from the center 26, i.e. a distance from the center 26, such as at a distance above 0.5, see reference 28. This corresponds to a hearing device not being worn in the operational position in or at the ear of a user, that is a hearing device in the first state. That is a state for which the hearing device fitting was not performed, and thus does not correspond to a state for which antenna matching was performed to optimize antenna performance. As is seen from FIG. 5, the hearing device in the first state has a high reflection coefficient, for example such that there is more than 50% reflected power.

The Smith chart also shows a detected phase of reflection coefficient. The first threshold may additionally be determined, or confirmed, based on a detected shift in phase of the reflection coefficient. For example, if a shift in phase above 90 deg, such as above 120 deg, such as above 180 deg, is detected, the processing unit may determine that a change in position of the hearing device has occurred.

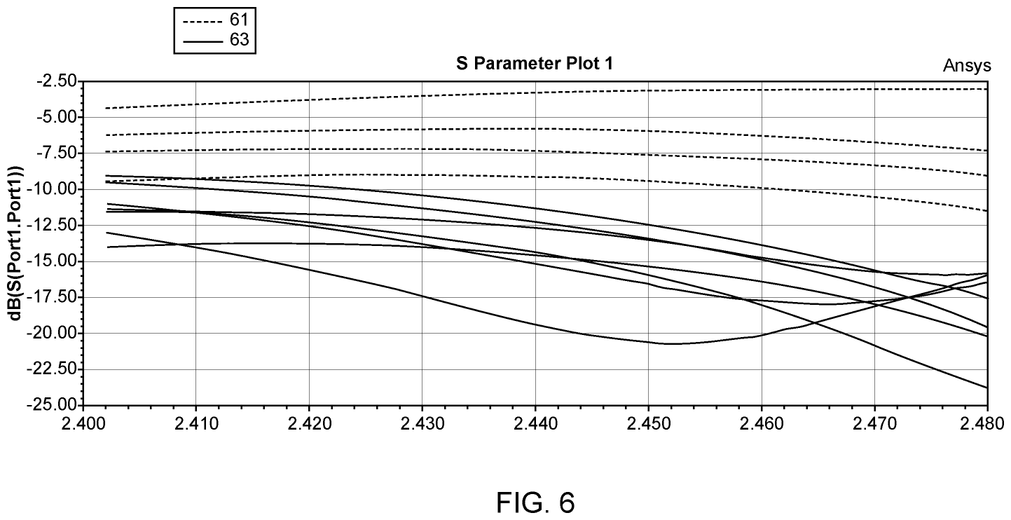

In FIG. 6 a graph illustrating the reflection coefficient versus frequency is shown. The graph shows detected magnitude of the reflection coefficient for the antenna.

The reflection coefficient is illustrated for an antenna in a hearing device configured for being positioned in or at the ear of a user during operation, thus the antenna is matched for the environment of an ear of a user.

In the graph, the top curve illustrates the reflection coefficient, in the present example being the magnitude of the reflection coefficient, in free space, that is for an antenna in a hearing device provided in free space, away from an ear of a user. It is seen that an S value of −3.31 is obtained at 2.4 GHz, corresponding to 50% of the power of the wireless output signal 16 being reflected back towards the wireless communication unit 5 from the antenna 3. It is seen that the curves 61 illustrate the reflection coefficient for an antenna in a hearing device in the first state, that is for a hearing device not worn at or in the ear of a user. The curves 63 illustrate the reflection coefficient for an antenna in a hearing device in the second state, that is for an antenna in a hearing device worn at or in the ear of a user. It is seen that the lower most curve has a reflection of −19.39, that corresponds to about 1% of the power of the wireless output signal 16 being reflected towards the wireless communication unit from the antenna 3.

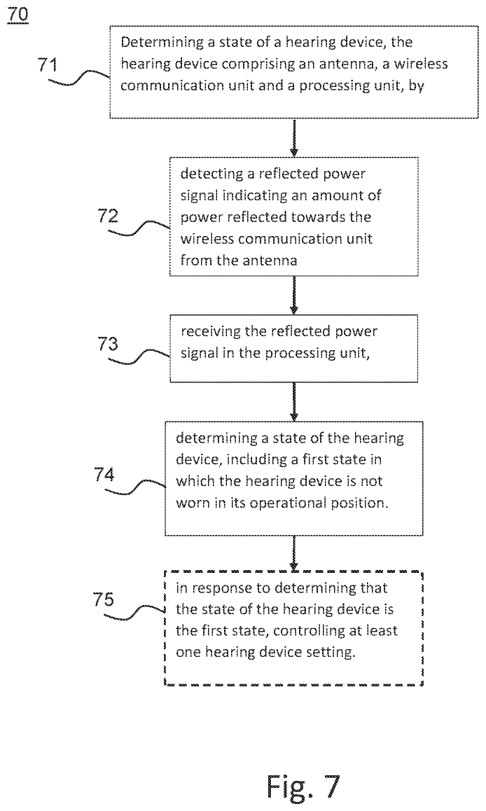

FIG. 7 is a flow chart showing the method of determining a state of a hearing device. The hearing device comprises an antenna, a wireless communication unit and a processing unit. The wireless communication unit is coupled to the antenna and the wireless communication unit and the antenna being configured for transmission and reception of electromagnetic signals. The method 70 of determining a state of the hearing device 71 comprises in step 72 detecting a reflected power signal indicating an amount of power reflected towards the wireless communication unit from the antenna. In step 73 receiving the reflected power signal in the processing unit, and in step 74 determining a state of the hearing device, including a first state in which the hearing device is not worn in its operational position.

The method may further comprise the step 75 of in response to determining that the state of the hearing device is the first state, controlling at least one hearing device setting.

The hearing device may comprise at least one hearing device transducer 13, 13′, 15, 15′, and the method comprises controlling an on/off setting of the at least one transducer 13, 13′, 15, 15′. The at least one hearing device setting may be a gain setting, and the method may comprise controlling a hearing device gain.

The hearing device in the first state may be configured to be operated in an idle mode, and wherein the hearing device in the second state is configured to be operated in one of a number of operational modes, the method further the method comprises: operating the hearing device in an idle mode in response to determining that the hearing device is in the first state; operating the hearing device in one of a number of operational modes, in response to determining that the hearing device is in the second state.

Although particular features have been shown and described, it will be understood that they are not intended to limit the claimed invention, and it will be made obvious to those skilled in the art that various changes and modifications may be made without departing from the scope of the claimed invention. Also, features described in connection with one illustrated exemplary device may equally be used in connection with another illustrated exemplary device. The specification and drawings are, accordingly to be regarded in an illustrative rather than restrictive sense. The claimed invention is intended to cover all alternatives, modifications and equivalents.

The present disclosure further includes the following embodiments:
1. A hearing device (1) comprising
an antenna (3),
a wireless communication unit (5), the wireless communication unit (5) being coupled to the antenna (3), the wireless communication unit (5) and the antenna (3) being configured for transmission and reception of electromagnetic signals,
a detector (9) configured to detect a reflected power signal indicating an amount of power reflected towards the wireless communication unit (5) from the antenna (3),
a processing unit (11) configured to receive the reflected power signal, and to determine a state of the hearing device, including a first state in which the hearing device is not worn in its operational position in or at the ear of a user.
2. The hearing device according to embodiment 1, wherein the processing unit (11) is configured to, in response to determining that the state of the hearing device is the first state, control at least one hearing device setting.
3. The hearing device according to embodiment 2, wherein the hearing device comprises at least one hearing device transducer (13, 15), and wherein the hearing device setting is an on/off setting of the at least one transducer.
4. The hearing device according to any of embodiments 2-3, wherein the hearing device comprises a plurality of hearing device transducers and wherein hearing device settings are controlled only for a part of the plurality of hearing device transducers.
5. The hearing device according to any of embodiments 2-4, wherein the at least one hearing device setting is a gain setting.
6. The hearing device according to any of the preceding embodiments, wherein the detector configured to detect the reflected power signal is provided in the wireless communication unit or in the processing unit.
7. The hearing device according to any of embodiments 1-6, wherein an interconnection (7) between the wireless communication unit and the antenna comprises at least one microwave coupler (17), and wherein the detector (9) is configured to detect coupled power from the microwave coupler (17).
8. The hearing device according to embodiment 7, wherein the microwave coupler (17) is configured to couple power reflected from the antenna (3) towards the wireless communication unit (5) to the detector (9) to provide the reflected power signal.
9. The hearing device according to embodiment 8, wherein the microwave coupler (17) comprises at least a part of a transmission line (7) coupling the wireless communication unit (5) and the antenna (3).
10. The hearing device according to any of the preceding embodiments, wherein in accordance with a determination that the reflected power signal indicates that the reflected power is above a first threshold, determining that the hearing device is in the first state, and/or in accordance with a determination that a change in the reflected power signal is above a second threshold, determining that the hearing device is in the first state.
11. The hearing device according to embodiment 10, wherein the first threshold and/or the second threshold are determined during a fitting procedure of the hearing device.
12. The hearing device according to any of the preceding embodiments, wherein the hearing device further has a second state in which the hearing device is worn in its operational position at the ear of a user.
13. The hearing device according to any of the preceding embodiments, wherein the hearing device in the first state is configured to be operated in an idle mode, and wherein the hearing device in the second state is configured to be operated in one of a number of operational modes.
14. The hearing device according to embodiment 13, wherein the processing unit is configured to, in response to determining that the state of the hearing device is the first state, operate the hearing device in idle mode, and wherein the processing unit is configured to, in response to determining that the state of the hearing device is the second state, operate the hearing device in one of a number of operational modes.
15. The hearing device according to any of the preceding embodiments, wherein the reflected power signal indicating an amount of power reflected towards the wireless communication unit corresponds to a reflection coefficient of the antenna.
16. The hearing device according to any of the preceding embodiments, wherein the reflected power signal indicating an amount of power reflected towards the wireless communication unit is detected as a function of frequency and time.
17. The hearing device according to embodiment 16, further comprising a memory (19) configured to store reflected power signals as a function of frequency and time.
18. The hearing device according to any of the preceding embodiments, wherein the antenna is configured to emit and transmit electromagnetic radiation at a frequency above 1 GHz.
19. The hearing device according to any of the preceding embodiments, wherein the hearing device further comprises hearing device charging elements (23).
20. The hearing device according to any of the preceding embodiments, the hearing device further comprising a matching network, the matching network (25) being configured to match antenna impedance and wireless communication unit impedance, to optimize power delivered to the antenna, when the hearing device is worn in its operational position at the ear of a user during use.
21. A method of determining a state of a hearing device,
the hearing device comprising an antenna, a wireless communication unit and a processing unit,
the wireless communication unit being coupled to the antenna, the wireless communication unit and the antenna being configured for transmission and reception of electromagnetic signals, the method comprising:
detecting a reflected power signal indicating an amount of power reflected towards the wireless communication unit from the antenna,
receiving the reflected power signal in the processing unit, and determining a state of the hearing device, including a first state in which the hearing device is not worn in its operational position.
22. The method according to embodiment 21, the method further comprising in response to determining that the state of the hearing device is the first state, controlling at least one hearing device setting.
23. The method according to embodiment 22, wherein the hearing device comprises at least one hearing device transducer, and wherein the method comprises controlling an on/off setting of the at least one transducer.
24. The method according to any of embodiments 21-23, wherein the at least one hearing device setting is a gain setting, and wherein the method comprises controlling a hearing device gain.
25. The method according to any of embodiments 21-24, wherein the hearing device in the first state is configured to be operated in an idle mode, and wherein the hearing device in the second state is configured to be operated in one of a number of operational modes, the method further comprising:
operating the hearing device in an idle mode in response to determining that the hearing device is in the first state;
operating the hearing device in one of a number of operational modes, in response to determining that the hearing device is in the second state.
26. A system comprising
   a hearing device according to any of claims 1-20, and
   a charger,
wherein the hearing device comprises hearing device charging elements configured to enable charging of a rechargeable battery and wherein the charger is configured to re-charge a rechargeable battery of the hearing device, characterized in that the hearing device is configured to be operating in the first state when connected to the charger.

### LIST OF REFERENCES

1 hearing device
3 antenna
5 wireless communication unit
7 interconnection, transmission line
9 detector
11 processing unit
12 hearing device housing
12′ behind-the-ear part
12″ in-the-ear part
13, 13′ hearing device transducer, microphone
15, 15′ hearing device transducer, speaker
16 wireless output signal
16′ reflected signal
17 microwave coupler
18 reflected power signal
19 memory
20 parasitic conducting element
21 rechargeable battery
23 hearing device charging elements
25 matching network
26 center—ideal match
28 high measured reflection coefficient
29 low measured coefficient
30 system
31 charger
33 charging elements
61 curves illustrating the reflection coefficient for an antenna in a hearing device in the first state,
63 curves illustrating the reflection coefficient for an antenna in a hearing device in the second state,
70 method of determining a state of a hearing device
71, 72, 73, 74, 75 method steps

1. A hearing device comprising:
an antenna;
a wireless communication unit, the wireless communication unit being coupled to the antenna, the wireless communication unit and the antenna are configured for signal transmission and signal reception;
a detector configured to detect a reflected power signal indicating an amount of power reflected towards the wireless communication unit from the antenna;
a processing unit configured to determine the hearing device as in a first state when the hearing device is not worn in its operational position in or at an ear of a user.

2. The hearing device according to claim 1, wherein the processing unit is configured to control a hearing device setting after determining that the hearing device is in the first state.

3. The hearing device according to claim 2, further comprising a hearing device transducer, and wherein the hearing device setting is an on/off setting of the transducer.

4. The hearing device according to claim 2, wherein the hearing device setting is a gain setting.

5. The hearing device according to claim 1, wherein the wireless communication unit and the antenna are coupled to each other via at least one microwave coupler, the at least one microwave coupler being configured to couple power reflected from the antenna towards the wireless communication unit to the detector, and wherein the detector is configured to detect the coupled power from the at least one microwave coupler as the detected reflected power signal.

6. The hearing device according to claim 5, wherein the at least one microwave coupler comprises at least a part of a transmission line coupling the wireless communication unit and the antenna.

7. The hearing device according to claim 1, wherein the hearing device is in a second state when the hearing device is worn in its operational position in or at the ear of the user.

8. The hearing device according to claim 7, wherein the hearing device is configured to be operated in an idle mode when the hearing device is in the first state, and wherein the hearing device is configured to be operated in one of a number of operational modes when the hearing device is in the second state.

9. The hearing device according to claim 1, wherein the reflected power signal indicating the amount of power reflected towards the wireless communication unit corresponds to a reflection coefficient of the antenna.

10. The hearing device according to claim 1, wherein the detector is configured to detect the reflected power signal as a function of frequency and time.

11. The hearing device according to claim 1, further comprising a memory configured to store the reflected power signal and other reflected power signals as a function of frequency and time.

12. The hearing device according to claim 1, wherein the wireless communication unit and the antenna are configured for electromagnetic-signal transmission and electromagnetic-signal reception.

13. A system comprising:
the hearing device according to claim 1, and
a charger;
wherein the charger is configured to charge a rechargeable battery of the hearing device, and wherein the hearing device is configured to be operated in the first state when connected to the charger.

14. A method performed by a hearing device having an antenna, a wireless communication unit, and a processing unit, the wireless communication unit being coupled to the antenna, the wireless communication unit and the antenna being configured for signal transmission and signal reception, the method comprising:
detecting a reflected power signal indicating an amount of power reflected towards the wireless communication unit from the antenna; and
determining the hearing device as being in a first state when the hearing device is not worn in its operational position.

15. The method according to claim 14, further comprising controlling a hearing device setting after the hearing device is determined as being in the first state.

16. The method according to claim 15, wherein the hearing device comprises at least one hearing device transducer, and wherein the hearing device setting is an on/off setting of the transducer.

17. The method according to claim 15, wherein the hearing device setting is a gain setting.
